(19) United States
(12) Patent Application Publication
(10) Pub. No.: US 2006/0080739 A1
(43) Pub. Date: Apr. 13, 2006

(54) System and methods for securing port to port communications on Layer 2 Ethernet switching devices.

(75) Inventor: Timothy Peter Lawton, Bailey, CO (US)

Correspondence Address: TIMOTHY P. LAWTON, 763 DESPARADO ROAD, BAILEY, CO, 80421, US

(73) Assignee: Timothy Peter Lawton, Bailey, CO (US)

(21) Appl. No.: 10/711,856

(22) Filed: Oct. 10, 2004

(51) Int. Cl. H04N 7/16

(52) U.S. Cl. 726/26

(57) ABSTRACT

The invention uses a layer 2 Ethernet switching device to establish two new port types, ‘trusted ports’ and ‘un-trusted ports’. Devices connected to trusted ports on the switch (such as centrally managed file, email, print, and web servers) are permitted by default to transmit to and receive data from any device attached to the switch, whether attached to a trusted or an un-trusted port. Devices connected to un-trusted ports (such as end-user laptops, workstations, mobile devices, and other systems at greater risk of virus and worm infection), are permitted only to establish connections to devices attached to the trusted ports on the switch. The premise of the invention is provide a simplified system and methods to safeguard the confidentially, availability, and integrity of network-based information assets by reducing the total number of computer systems that an unauthorized user or application (e.g., hacker, worm, or virus) can connect to and attempt to exploit vulnerabilities on.

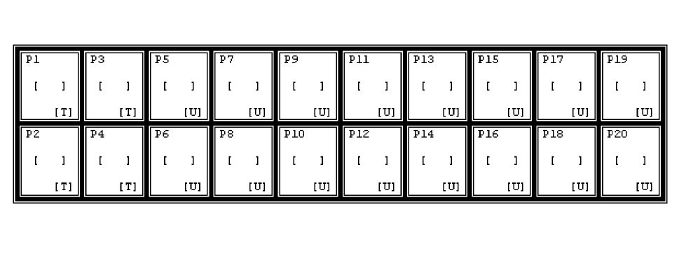

### REFERENCES CITED

U.S. patent Documents

U.S. Pat. No. 6,741,592 May, 2000 Edsall, et al.

### FIELD OF THE INVENTION

The invention relates to a hardware system an associated methods for designating the physical ports of an Ethernet switch as trusted or un-trusted, and more particularly provides a simplified method to control Level 2 communication between ports relative to their designation as trusted or un-trusted.

### BACKGROUND OF THE INVENTION

The basic premise of a Layer 2 Ethernet switch is to quickly establish a path of communication between network computing devices attached to the ports of the switch. However, the basic functionality of a switch is readily exploitable as demonstrated by the increasing ease at which computer viruses and worms successfully propagate between networked computer systems. As such, a need has arisen to deny access between all ports on a Layer 2 Ethernet switch by default, and simplify the process by which ports are explicitly permitted to participate in network communications. The goal of the invention is to promote the adoption of port isolation network switches by simplifying the method by which such switches can be implemented and administered.

### SUMMARY OF INVENTION

The invention consists of a system and methods to improve the security of network computing devices attached to a Layer 2 Ethernet switch.

The first method of security improvement consists of the addition of a mode selection button for each Ethernet port on the switch. The mode selection button is used to modify the communications behavior of the port from trusted mode to un-trusted mode. In trusted mode, the port is capable of receiving communications from any other port on the switch. In un-trusted mode, the port is capable of communicating only with devices attached to ports configured in trusted mode.

The second method of security improvement consists of modifying the default out-of-the-box behavior of the Layer 2 Ethernet switch. Instead of permitting communications between all ports, each port on the switch will initially be configured in ‘un-trusted’ mode thereby denying communication between all ports unless explicitly allowed.

### DETAILED DESCRIPTION OF INVENTION

Distinguishing characteristics of this invention include 1) utilization of a trusted port technology which enables individual ports on the switch to transmit to and receive data from all other ports on the switch, 2) utilization of an un-trusted port technology which enables individual ports on the switch to transmit to and receive data from trusted ports only, thereby preventing devices attached to such ports from communicating with devices attached to other un-trusted ports, 3) utilization of a ‘push button’ method to toggle between trusted and un-trusted port modes for each Layer 2 port, 4) utilization of a default deny all port to port communication policy which must be explicitly overridden on a port by port basis.

### DETAILED DESCRIPTION OF DRAWING

The enclosed drawing is a simplified view of the invention, and represents a standard Layer 2 Ethernet Switch face plate modified with the components of the invention. This conceptual Layer 2 Ethernet switch consists of 20 ports (denoted as P1-P20).

In the center of each square is the standard Ethernet connection port (denoted as [ ]). The hardware portion of the invention is represented as the mode selection button, and denoted as [U] if selected for operation in un-trusted mode, and [T] if selected for operation in trusted mode.

Devices that would typically be attached to the trusted mode ports could include servers such as email, DNS, file, print, internal web, and other shared network resources. Devices attached to un-trusted ports could include laptops, personal workstations, and other single user computer systems that generally have a higher risk of containing malicious code such as worms or viruses.

When the network is operated using the configuration of the above Layer 2 Ethernet switch, all devices connected to the ports with the mode selection button in position [U] are quarantined from all other devices connected with ports labeled [U]. In practice, this would prevent a device with a Win-32 based worm on port P5 from scanning for other Win-32 based systems on ports P6 through P20, and attempting to exploit an existing system vulnerability. The design of the invention does not prevent an infected device from attempting to scan systems attached to ports P1-P4. However, it is assumed that the systems attached to ports P1-P4 are mission critical in nature, and therefore steps have been taken to harden the systems to an appropriate level of network security.

What is claimed is:

1. A manual push-button method of selecting a trusted or un-trusted mode of port to port communications on Layer 2 Ethernet switching devices.

2. A method by which a Layer 2 Ethernet switch operates individual ports. The first mode of port operation, trusted mode, enables the device attached to the port to transmit data to or receive data from any other port on the switch (both trusted and un-trusted ports). The second mode of port operation, un-trusted mode, limits the device attached to the un-trusted port to transmit data to and receive data from trusted ports only, thereby prohibiting communication to and from all other device with attached to un-trusted ports.
